(19) United States
(12) Patent Application Publication
(10) Pub. No.: US 2006/0294049 A1
(43) Pub. Date: Dec. 28, 2006

(54) Back-off mechanism for search

(75) Inventors: Stuart Sechrest, Redmond, WA (US); Yevgeniy A. Samsonov, Redmond, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 11/167,826

(22) Filed: Jun. 27, 2005

(51) Int. Cl. G06F 17/30

(52) U.S. Cl. 707/1

(57) ABSTRACT

Indexing documents is performed using low priority I/O requests. This aspect can be implemented in systems having an operating system that supports at least two priority levels for I/O requests to its filing system. Low priority I/O requests can be used for accessing documents to be indexed. Low priority I/O requests can also be used for writing information into the index. Higher priority requests can be used for I/O requests to access the index in response queries from a user. I/O request priority can be set on a per-thread basis as opposed to being set on a per-process basis (which may generate two or more threads for which it may be desirable to assign different priorities).

### BACKGROUND

Some operating systems designed for personal computers (including laptop/notebook computers and handheld computing devices, as well as desktop computers) have a full-text search system that allows a user to search for selected word or words in the text of documents stored in the personal computer. Some full-text search systems include an indexing sub-system that basically inspects documents stored in the personal computer and stores each word of the document in an index so that a user may perform indexed searches using key words. This indexing process is a central processing unit (CPU) and is input/output (I/O) intensive. Thus, if a user wishes to perform another activity while the indexing process is being performed, the user will typically experience delays in processing of this activity, which tends to adversely impact the “user-experience”.

One approach to minimizing delays in responding to user activity during the indexing process is to pause the indexing when user activity is detected. The full-text search system can include logic to detect user activity and “predict” when the user activity has finished (or idle period) so that the indexing process can be restarted. When user activity is detected, the indexing process can be paused, but typically there is still a delay as the indexing process transitions to the paused state (e.g., to complete an operation or task that is currently being performed as part of the indexing process). Further, if a prediction of an idle period is incorrect, the indexing process will cause the aforementioned delays that can degrade user experience. Still further, the logic used to detect user activity and idle periods increases the complexity of the full-text search system and consumes CPU resources. Although some shortcomings of conventional systems are discussed, this background information is not intended to identify problems that must be addressed by the claimed subject matter.

### SUMMARY

This summary is provided to introduce a selection of concepts in a simplified form that are further described below in the Detailed Description Section. This summary is not intended to identify key features or essential features of the claimed subject matter, nor is it intended to be used as an aid in determining the scope of the claimed subject matter.

According to aspects of various described embodiments, indexing documents is performed using low priority I/O requests. This aspect can be implemented in systems having an operating system that supports at least two priority levels for I/O requests to its filing system. In some implementations, low priority I/O requests are used for accessing documents to be indexed and for writing information into the index, while higher priority requests are used for I/O requests to access the index in response to queries from a user. Also, in some implementations, I/O request priority can be set on a per-thread basis as opposed to being set on a per-process basis (which may generate two or more threads for which it may be desirable to assign different priorities).

Embodiments may be implemented as a computer process, a computer system (including mobile handheld computing devices) or as an article of manufacture such as a computer program product. The computer program product may be a computer storage medium readable by a computer system and encoding a computer program of instructions for executing a computer process. The computer program product may also be a propagated signal on a carrier readable by a computing system and encoding a computer program of instructions for executing a computer process.

### BRIEF DESCRIPTION OF THE DRAWINGS

Non-limiting and non-exhaustive embodiments are described with reference to the following figures, wherein like reference numerals refer to like parts throughout the various views unless otherwise specified.

FIG. 1 is a diagram illustrating an exemplary system with a search/indexing process and a file system supporting high and low priority I/O requests, according to one embodiment.

FIG. 2 is a diagram illustrating an exemplary searching/indexing system, according to one embodiment.

FIG. 3 is a flow diagram illustrating operational flow of an indexing process in sending I/O requests to a file system, according to one embodiment.

FIG. 4 is a flow diagram illustrating operational flow in indexing a document, according to one embodiment.

FIG. 5 is a block diagram illustrating an exemplary computing environment suitable for implementing the systems and operational flow of FIGS. 1-5, according to one embodiment.

### DETAILED DESCRIPTION

Various embodiments are described more fully below with reference to the accompanying drawings, which form a part hereof, and which show specific exemplary embodiments for practicing the invention. However, embodiments may be implemented in many different forms and should not be construed as limited to the embodiments set forth herein; rather, these embodiments are provided so that this disclosure will be thorough and complete, and will fully convey the scope of the invention to those skilled in the art. Embodiments may be practiced as methods, systems or devices. Accordingly, embodiments may take the form of a hardware implementation, an entirely software implementation or an implementation combining software and hardware aspects. The following detailed description is, therefore, not to be taken in a limiting sense.

The logical operations of the various embodiments are implemented (a) as a sequence of computer implemented steps running on a computing system and/or (b) as interconnected machine modules within the computing system. The implementation is a matter of choice dependent on the performance requirements of the computing system implementing the embodiment. Accordingly, the logical operations making up the embodiments described herein are referred to alternatively as operations, steps or modules.

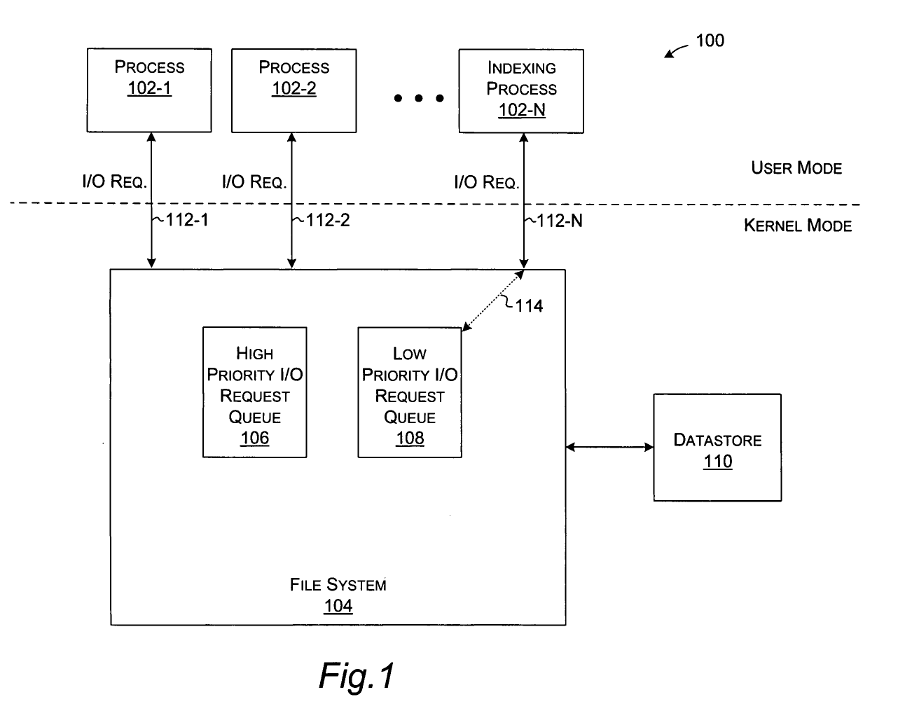

FIG. 1 illustrates a system 100 that supports low priority I/O requests for indexing documents for searching purposes. In this exemplary embodiment, system 100 includes user processes 102-1 through 102-N, a file system 104 that supports high and low priority I/O requests (e.g., using a high priority I/O request queue 106 and a low priority I/O request queue 108), and a datastore 110 (e.g., a disk drive) that can be used to store documents to be indexed for searching purposes. Any suitable file system that supports high and low priority I/O requests can be used to implement file system 104. In one embodiment, file system 104 implements high and low priority I/O request queues 106 and 108 as described in U.S. Patent Application Publication No. US2004/0068627A1, entitled “Methods and Mechanisms for Proactive Memory Management”, published Apr. 8, 2004.

Although the terms “low priority” and “high priority” are used above, these are used as relative terms in that low priority I/O requests have a lower priority than high priority I/O requests. In some embodiments, different terms may be used such as, for example, “normal” and “low” priorities. In other embodiments, there may be more than two levels of priority available for I/O requests. In such embodiments, I/O requests for indexing can be sent at the lowest priority, allowing I/O requests from other processes and/or threads to be sent at the higher priorities levels.

In this exemplary embodiment, user process 102-N is an indexing process to index documents for searching purposes (e.g., full-text search of documents). For example, indexing process 102-N can write all of the words of a document into an index (repeating this for all of the documents stored in system 100), which can then be used to perform full-text searches of the documents stored in system 100.

The other user processes (e.g., user processes 102-1 and 102-2) can be any other process that can interact with file system 104 to access files stored in datastore 110. Depending on the user's activities, there may be many user processes being performed, a small number of user processes being performed, or in some scenarios just indexing process 102-N being performed (which may be terminated if all of the documents in datastore 110 have been indexed).

In operation, user processes 102-1 through 102-N will typically send I/O requests to file system 104 from time-to-time, as indicated by arrows 112-1 through 112-N. For many user processes, these I/O requests are sent with high priority. For example, foreground processes such as an application (e.g., a word processor) responding to user input, a media player application playing media, a browser downloading a page, etc. will typically send I/O requests at high priority.

However, in accordance with this embodiment, all I/O requests sent by indexing process 102-N are sent at low priority and added to low priority I/O request queue 108, as indicated by an arrow 114. In this way, the I/O requests from indexing process 102-N will be performed after all of the high priority I/O requests in high priority I/O request queue 106 have been serviced. This feature can advantageously reduce user-experience degradation caused by the indexing processes in some embodiments. Further, in some embodiments, idle-detection logic previously discussed is eliminated, thereby reducing the complexity of the indexing sub-system. Still further, using low priority I/O requests for indexing processes avoids the problems of errors in detecting idle periods and delays in pausing the indexing process that are typically present in idle-detection schemes.

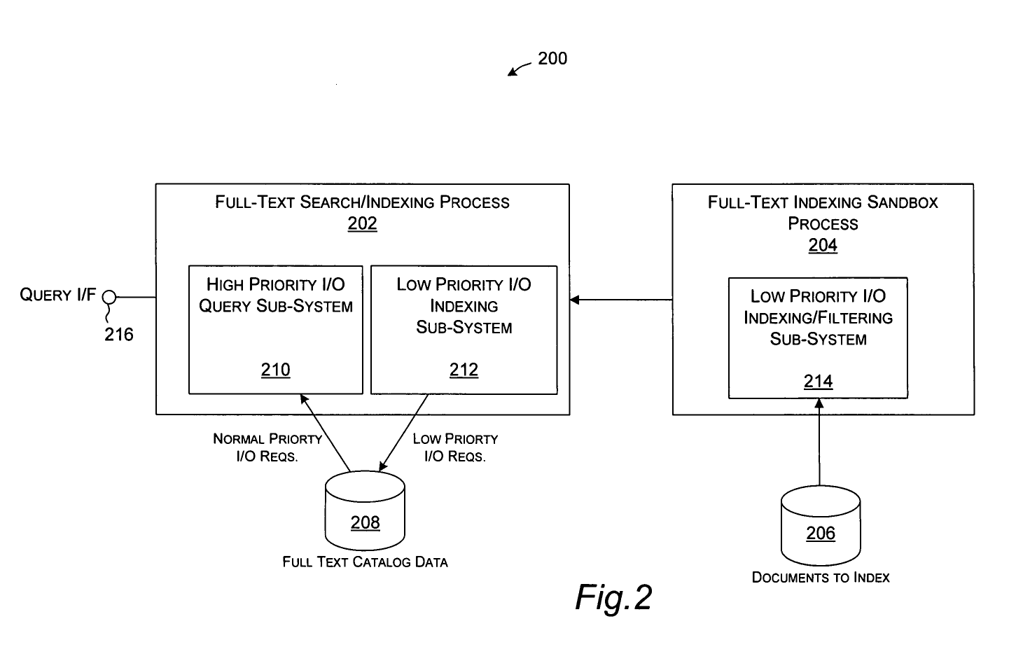

FIG. 2 illustrates an exemplary search/indexing system 200, according to one embodiment. In this embodiment, system 200 includes a full-text search/indexing process (or main process) 202, a full-text indexing sandbox process (or sandbox process) 204, a document datastore 206, and a full-text catalog data (or index) datastore 208. In this embodiment, main process 202 includes a high priority I/O query subsystem (or query subsystem) 210 and a low priority I/O indexing subsystem 212. Sandbox process 204 is used to isolate components that convert documents of different formats into plain text, in this embodiment, and includes a low priority I/O indexing/filtering subsystem (or filtering subsystem) 214.

In this embodiment, query subsystem 210 handles search queries from a user, received via an interface 216. The user can enter one or more key words to be searched for in documents stored in system 200. In some embodiments, responsive to queries received via interface 216, query subsystem 210 processes the queries, and accesses index datastore 208 via high priority I/O requests. For example, query subsystem 210 can search the index for the key word(s) and obtain from the index a list of document(s) that contain the key word(s). In embodiments in which CPU priority can be selected for processes and/or threads, query subsystem 210 can be set for high priority CPU processing. Such a configuration (i.e., setting the I/O and CPU priorities to high priority) can be advantageous because users typically want search results as soon as possible and are willing to dedicate the system resources to the search.

In this embodiment, low priority I/O indexing subsystem 212 builds the index used in full-text searching of documents. For example, low priority I/O indexing subsystem 212 can obtain data (e.g., words and document identifiers of the documents that contain the words) from sandbox process 204, and then appropriately store this data in index datastore 208. Writing data to index datastore 208 is relatively I/O intensive. Building the index (e.g., determining what data is to be stored in index datastore 208, and how it is to be stored in index datastore 208) is relatively CPU intensive. In accordance with this embodiment, low priority I/O indexing subsystem 212 stores the data in index datastore 208 using low priority I/O requests. In embodiments in which CPU priority can be selected for processes and/or threads, low priority I/O indexing subsystem 212 can be set for low priority CPU processing. Such a configuration (i.e., setting the I/O and CPU priorities to low priority) can be advantageous because users typically want fast response to user activities (e.g., user inputs for executing applications, media playing, file downloading, etc.) and are willing to delay the indexing process.

In this embodiment, filtering subsystem 214 retrieves documents from document datastore 206 and processes the documents to extract the data needed by low priority I/O indexing subsystem 212 to build the index. Filtering subsystem 214 reads the content and metadata from each document obtained from document datastore 206 and from the documents extracts words that users can search for in the documents using query subsystem 210. In one embodiment, filtering subsystem 214 includes filter components that can convert a document into plain text, perform a word-breaking process, and place the word data in a pipe so as to be available to low priority I/O indexing subsystem 212 for building the index. In other embodiments, word-breaking is done by low priority I/O indexing subsystem 212.

Although system 200 is illustrated and described with particular modules or components, in other embodiments, one or more functions described for the components or modules may be separated into another component or module, combined into fewer modules or components, or omitted.

Exemplary “I/O Request” Operational Flow

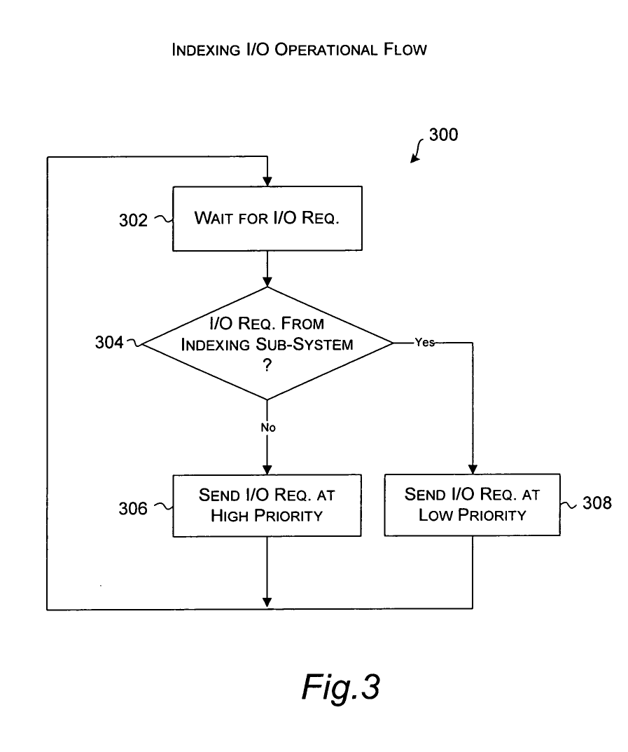

FIG. 3 illustrates operational flow 300 of an indexing process in sending I/O requests to a file system, according to one embodiment. Operational flow 300 may be performed in any suitable computing environment. For example, operational flow 300 may be executed by an indexing process such as main process 202 of system 200 (FIG. 2) to process document(s) stored on a datastore of a system and create an index used in performing a full-text search of the stored document(s). Therefore, the description of operational flow 300 may refer to at least one of the components of FIG. 2. However, any such reference to components of FIG. 2 is for descriptive purposes only, and it is to be understood that the implementations of FIG. 2 are a non-limiting environment for operational flow 300.

At a block 302, the indexing process waits for an I/O request. In one embodiment, the indexing process is implemented as main process 202 (FIG. 2) in which low priority I/O requests can be generated by an indexing subsystem, and high priority I/O requests can be generated by a search query subsystem. For example, the indexing subsystem may be implemented with an indexing subsystem such as low priority I/O indexing subsystem 212 together with a filtering subsystem such as filtering subsystem 214. The search query subsystem can be implemented using any suitable query-processing component such as, for example query subsystem 210. Operational flow 300 can proceed to a block 304.

At block 304, it is determined whether the I/O request is from the indexing subsystem. In one embodiment, the indexing process determines whether the I/O request is from the indexing subsystem by inspecting the source of the request. Continuing the example described above for block 302, if for example the I/O request is from the indexing subsystem to write information into the index, or if the I/O request is from the filtering subsystem to access documents stored in a documents datastore, then the indexing system will determine that the I/O request is from the indexing subsystem and operational flow 300 can proceed to a block 308 described further below. However, if for example the I/O request is from the query subsystem to search the index for specified word(s), then the indexing system will determine that the I/O request is not from the indexing subsystem and operational flow 300 can proceed to a block 306. In one embodiment, the operating system is implemented to allow setting the priority of filing system I/O requests on a per-thread basis as opposed to a per-process basis. Such a feature can be advantageously used in embodiments in which the query subsystem and the indexing subsystem are part of the same process (e.g., main process 202 of FIG. 2) to allow the user-initiated query I/O requests to be sent at high priority while indexing subsystem-initiated I/O requests can be sent at low priority.

At block 306, the I/O request is sent to the file system at high priority. In one embodiment, the indexing system sends the I/O request to a high priority queue such as high priority I/O request queue 106 (FIG. 1). Operational flow 300 can then return to block 302 to wait for another I/O request.

At block 308, the I/O request is sent to the file system at low priority. In one embodiment, the indexing system sends the I/O request to a low priority queue such as low priority I/O request queue 108 (FIG. 1). Operational flow 300 can then return to block 302 to wait for another I/O request.

Although operational flow 300 is illustrated and described sequentially in a particular order, in other embodiments, the operations described in the blocks may be performed in different orders, multiple times, and/or in parallel. Further, in some embodiments, one or more operations described in the blocks may be separated into another block, omitted or combined.

Exemplary “Document Indexing” Operational Flow

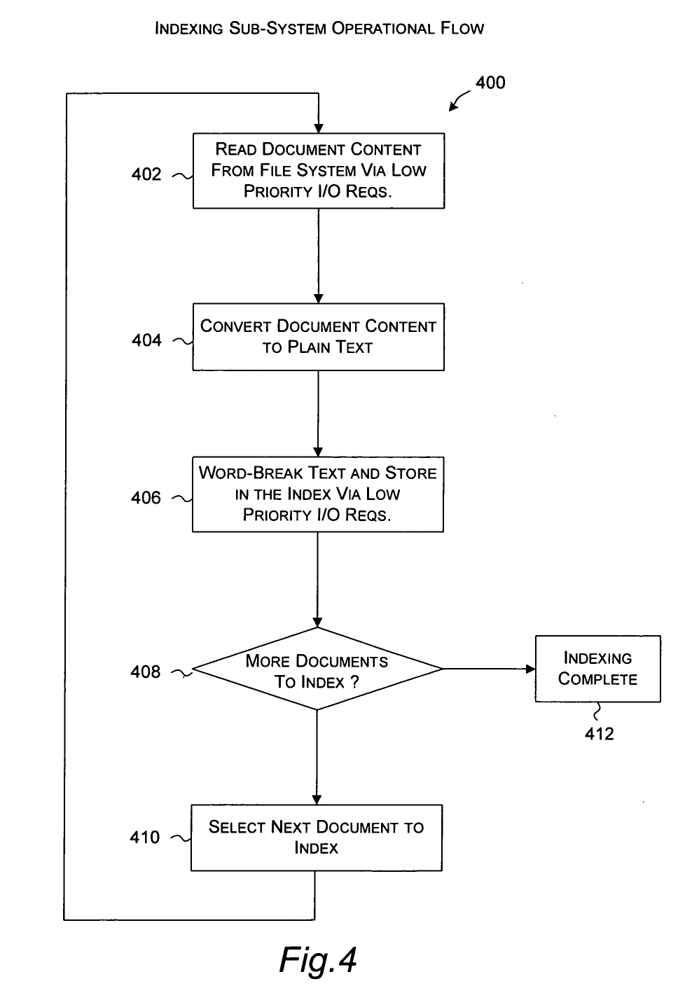

FIG. 4 illustrates an operational flow 400 in indexing a document, according to one embodiment. Operational flow 400 may be performed in any suitable computing environment. For example, operational flow 300 may be executed by an indexing process such as main process 202 of system 200 (FIG. 2) to process document(s) stored on a datastore of a system and create an index used in performing a full-text search of the stored document(s). Therefore, the description of operational flow 400 may refer to at least one of the components of FIG. 2. However, any such reference to components of FIG. 2 is for descriptive purposes only, and it is to be understood that the implementations of FIG. 2 are a non-limiting environment for operational flow 400.

At a block 402, a document is obtained from a file system. In one embodiment, an indexing system such as system 200 (FIG. 2) reads the document from a document datastore such as datastore 206 (FIG. 2). In accordance with this embodiment, the document is read from the datastore using low priority I/O requests. For example, the indexing system may include a filtering subsystem such as filtering subsystem 214 (FIG. 2) that can generate an I/O request to read a document from the document datastore. Such an indexing system can be configured to detect I/O requests from the filtering subsystem (as opposed to a query subsystem) and send them to the filing system as low priority I/O requests. Operational flow 400 can proceed to a block 404.

At block 404, the document obtained at block 402 is converted into a plain text document. In one embodiment, after the document is read into memory, the aforementioned filtering subsystem converts the document into a plain text document. For example, the document may include formatting metadata, mark-up (if the document is a mark-up language document), etc. in addition to the text data. Operational flow 400 can proceed to a block 406.

At block 406, the plain text document obtained at block 404 is processed to separate the plain text document into individual words (i.e., a word-breaking process is performed). In one embodiment, an indexing subsystem such as low priority I/O indexing subsystem 212 (FIG. 2) can perform the word-breaking process. In addition, in accordance with this embodiment, the separated words are then stored in an index using low priority I/O requests. Continuing the example described for block 402, the aforementioned indexing system (which includes the indexing subsystem) is configured to detect I/O requests from the indexing subsystem. In such an embodiment, the indexing system sends the I/O requests detected as being from the indexing subsystem to the filing system as low priority I/O requests. Operational flow 400 can proceed to a block 408.

At block 408, it is determined whether there are more documents to be indexed. In one embodiment, the indexing system determines whether there are more documents to be indexed by inspecting the aforementioned document datastore for documents that have not been indexed. For example, the aforementioned filtering subsystem can inspect the document datastore using low priority I/O requests. If it is determined that there are one or more other documents to index, operational flow 400 can proceed to a block 410.

At block 410, a next document to be indexed is selected. In one embodiment, the aforementioned filtering subsystem selects the next document from the document datastore to be indexed. Operational flow 400 can return to block 402 to index the document.

However, if at block 408 it is determined that there are no more documents to be indexed, operational flow 400 can proceed to a block 412, at which the indexing process is completed.

Although operational flow 400 is illustrated and described sequentially in a particular order, in other embodiments, the operations described in the blocks may be performed in different orders, multiple times, and/or in parallel. Further, in some embodiments, one or more operations described in the blocks may be separated into another block, omitted or combined.

Illustrative Operating Environment

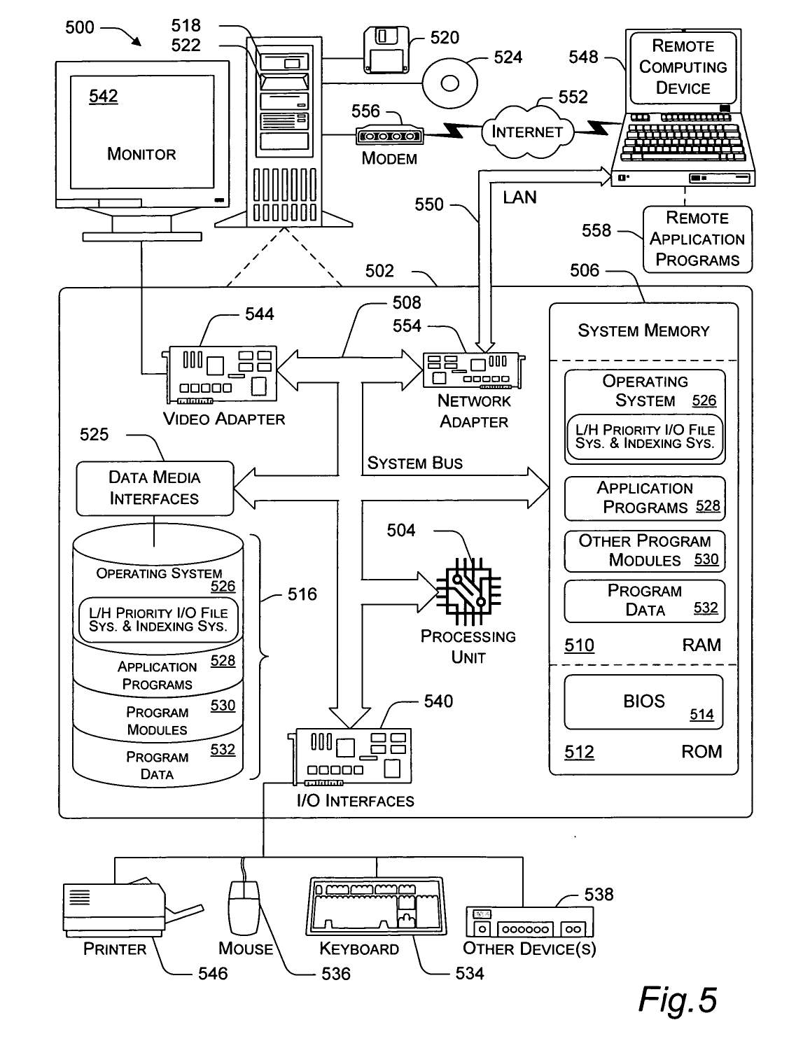

FIG. 5 illustrates a general computer environment 500, which can be used to implement the techniques described herein. The computer environment 500 is only one example of a computing environment and is not intended to suggest any limitation as to the scope of use or functionality of the computer and network architectures. Neither should the computer environment 500 be interpreted as having any dependency or requirement relating to any one or combination of components illustrated in the example computer environment 500.

Computer environment 500 includes a general-purpose computing device in the form of a computer 502. The components of computer 502 can include, but are not limited to, one or more processors or processing units 504, system memory 506, and system bus 508 that couples various system components including processor 504 to system memory 506.

System bus 508 represents one or more of any of several types of bus structures, including a memory bus or memory controller, a peripheral bus, an accelerated graphics port, and a processor or local bus using any of a variety of bus architectures. By way of example, such architectures can include an Industry Standard Architecture (ISA) bus, a Micro Channel Architecture (MCA) bus, an Enhanced ISA (EISA) bus, a Video Electronics Standards Association (VESA) local bus, a Peripheral Component Interconnects (PCI) bus also known as a Mezzanine bus, a PCI Express bus, a Universal Serial Bus (USB), a Secure Digital (SD) bus, or an IEEE 1394, i.e., FireWire, bus.

Computer 502 may include a variety of computer readable media. Such media can be any available media that is accessible by computer 502 and includes both volatile and non-volatile media, removable and non-removable media.

System memory 506 includes computer readable media in the form of volatile memory, such as random access memory (RAM) 510; and/or non-volatile memory, such as read only memory (ROM) 512 or flash RAM. Basic input/output system (BIOS) 514, containing the basic routines that help to transfer information between elements within computer 502, such as during start-up, is stored in ROM 512 or flash RAM. RAM 510 typically contains data and/or program modules that are immediately accessible to and/or presently operated on by processing unit 504.

Computer 502 may also include other removable/non-removable, volatile/non-volatile computer storage media. By way of example, FIG. 5 illustrates hard disk drive 516 for reading from and writing to a non-removable, non-volatile magnetic media (not shown), magnetic disk drive 518 for reading from and writing to removable, non-volatile magnetic disk 520 (e.g., a “floppy disk”), and optical disk drive 522 for reading from and/or writing to a removable, non-volatile optical disk 524 such as a CD-ROM, DVD-ROM, or other optical media. Hard disk drive 516, magnetic disk drive 518, and optical disk drive 522 are each connected to system bus 508 by one or more data media interfaces 525. Alternatively, hard disk drive 516, magnetic disk drive 518, and optical disk drive 522 can be connected to the system bus 508 by one or more interfaces (not shown).

The disk drives and their associated computer-readable media provide non-volatile storage of computer readable instructions, data structures, program modules, and other data for computer 502. Although the example illustrates a hard disk 516, removable magnetic disk 520, and removable optical disk 524, it is appreciated that other types of computer readable media which can store data that is accessible by a computer, such as magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like, can also be utilized to implement the example computing system and environment.

Any number of program modules can be stored on hard disk 516, magnetic disk 520, optical disk 524, ROM 512, and/or RAM 510, including by way of example, operating system 526 (which in some embodiments include low and high priority I/O file systems and indexing systems described above), one or more application programs 528, other program modules 530, and program data 532. Each of such operating system 526, one or more application programs 528, other program modules 530, and program data 532 (or some combination thereof) may implement all or part of the resident components that support the distributed file system.

A user can enter commands and information into computer 502 via input devices such as keyboard 534 and a pointing device 536 (e.g., a “mouse”). Other input devices 538 (not shown specifically) may include a microphone, joystick, game pad, satellite dish, serial port, scanner, and/or the like. These and other input devices are connected to processing unit 504 via input/output interfaces 540 that are coupled to system bus 508, but may be connected by other interface and bus structures, such as a parallel port, game port, or a universal serial bus (USB).

Monitor 542 or other type of display device can also be connected to the system bus 508 via an interface, such as video adapter 544. In addition to monitor 542, other output peripheral devices can include components such as speakers (not shown) and printer 546 which can be connected to computer 502 via I/O interfaces 540.

Computer 502 can operate in a networked environment using logical connections to one or more remote computers, such as remote computing device 548. By way of example, remote computing device 548 can be a PC, portable computer, a server, a router, a network computer, a peer device or other common network node, and the like. Remote computing device 548 is illustrated as a portable computer that can include many or all of the elements and features described herein relative to computer 502. Alternatively, computer 502 can operate in a non-networked environment as well.

Logical connections between computer 502 and remote computer 548 are depicted as a local area network (LAN) 550 and a general wide area network (WAN) 552. Such networking environments are commonplace in offices, enterprise-wide computer networks, intranets, and the Internet.

When implemented in a LAN networking environment, computer 502 is connected to local area network 550 via network interface or adapter 554. When implemented in a WAN networking environment, computer 502 typically includes modem 556 or other means for establishing communications over wide area network 552. Modem 556, which can be internal or external to computer 502, can be connected to system bus 508 via I/O interfaces 540 or other appropriate mechanisms. It is to be appreciated that the illustrated network connections are examples and that other means of establishing at least one communication link between computers 502 and 548 can be employed.

In a networked environment, such as that illustrated with computing environment 500, program modules depicted relative to computer 502, or portions thereof, may be stored in a remote memory storage device. By way of example, remote application programs 558 reside on a memory device of remote computer 548. For purposes of illustration, applications or programs and other executable program components such as the operating system are illustrated herein as discrete blocks, although it is recognized that such programs and components reside at various times in different storage components of computing device 502, and are executed by at least one data processor of the computer.

Various modules and techniques may be described herein in the general context of computer-executable instructions, such as program modules, executed by one or more computers or other devices. Generally, program modules include routines, programs, objects, components, data structures, etc. for performing particular tasks or implement particular abstract data types. Typically, the functionality of the program modules may be combined or distributed as desired in various embodiments.

An implementation of these modules and techniques may be stored on or transmitted across some form of computer readable media. Computer readable media can be any available media that can be accessed by a computer. By way of example, and not limitation, computer readable media may comprise “computer storage media” and “communications media.”

“Computer storage media” includes volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

“Communication media” typically embodies computer readable instructions, data structures, program modules, or other data in a modulated data signal, such as carrier wave or other transport mechanism. Communication media also includes any information delivery media. The term “modulated data signal” means a signal that has one or more of its characteristics set or changed in such a manner as to encode information in the signal. As a non-limiting example only, communication media includes wired media such as a wired network or direct-wired connection, and wireless media such as acoustic, RF, infrared, and other wireless media. Combinations of any of the above are also included within the scope of computer readable media.

Reference has been made throughout this specification to “one embodiment,” “an embodiment,” or “an example embodiment” meaning that a particular described feature, structure, or characteristic is included in at least one embodiment of the present invention. Thus, usage of such phrases may refer to more than just one embodiment. Furthermore, the described features, structures, or characteristics may be combined in any suitable manner in one or more embodiments.

One skilled in the relevant art may recognize, however, that the invention may be practiced without one or more of the specific details, or with other methods, resources, materials, etc. In other instances, well known structures, resources, or operations have not been shown or described in detail merely to avoid obscuring aspects of the invention.

While example embodiments and applications of the present invention have been illustrated and described, it is to be understood that the invention is not limited to the precise configuration and resources described above. Various modifications, changes, and variations apparent to those skilled in the art may be made in the arrangement, operation, and details of the methods and systems of the present invention disclosed herein without departing from the scope of the claimed invention.

What is claimed is:

1. A computer-implemented method for sending an input/output (I/O) request to a filing system, the method comprising:
waiting for an I/O request;
determining whether the I/O request was generated by an indexing subsystem, wherein the indexing subsystem is to create an index used to perform a word search of a document set; and
sending the I/O request at low priority responsive to determining that an indexing subsystem generated the I/O request.

2. The method of claim 1 further comprising selectively sending the I/O request at high priority responsive to determining that the I/O request was generated by a component other than the indexing subsystem.

3. The method of claim 1 wherein an I/O request generated in response to a search request is generated by a query subsystem and is sent at high priority.

4. The method of claim 1 wherein an I/O request generated in response to reading a document to be indexed is generated by the indexing subsystem.

5. The method of claim 1 wherein an I/O request generated in response to writing data into the index is generated by the indexing subsystem.

6. The method of claim 1 wherein priorities can be assigned to I/O requests on a per-thread basis.

7. The method of claim 1 further comprising assigning central processing unit (CPU) tasks generated by the indexing subsystem as low priority CPU tasks.

8. One or more computer-readable media having thereon instructions that when executed by a computer implement the method of claim 1.

9. A computer-implemented method for indexing a document, the method comprising:
reading content of a document from a file system using one or more low priority input/output (I/O) requests;
extracting words from the content; and
storing the extracted words in an index using one or more low priority I/O requests.

10. The method of claim 9 further comprising converting the content to plain text.

11. The method of claim 9 wherein the extracting is performed using a word-breaking process.

12. The method of claim 9 wherein the low priority I/O requests are associated with one or more low priority central processing unit (CPU) tasks.

13. The method of claim 9 wherein the index is selectively accessed using one or more high priority I/O requests responsive to a query generated by a user.

14. The method of claim 13 wherein the one or more I/O requests and the one or more I/O requests associated with the query are generated by different threads of the same process.

15. One or more computer-readable media having thereon instructions that when executed by a computer implement the method of claim 9.

16. A system to create an index used in searching one or more documents for one or more selected words, the system comprising:
a file system that supports at least low and high priority input/output (I/O) requests;
a datastore to store one or more documents to be indexed and the index, wherein the datastore is accessible via the file system; and
an indexing process to read one or more documents from the datastore and to store data in the index, wherein the indexing processes generates one or more low priority I/O requests to read the one or more documents from the datastore and generates one or more low priority I/O requests to store data in the index.

17. The system of claim 16 wherein the indexing process is also to send one or more high priority I/O requests to the file system in response to a search query that accesses the index.

18. The system of claim 16 wherein the low priority I/O requests are associated with one or more low priority central processing unit (CPU) tasks.

19. The method of claim 16 wherein the one or more low priority I/O requests and the one or more I/O requests associated with the query are generated by different threads of the same process.

20. One or more computer-readable media having thereon instructions that when executed by a computer implement the system of claim 16.
